(19) United States
(12) Patent Application Publication
(10) Pub. No.: US 2002/0134631 A1
(43) Pub. Date: Sep. 26, 2002

(54) Device for determining the pressure between a contact wire and a pantograph

(76) Inventors: Werner Brand, Moosburg (DE); Olaf Mollenhauer, Ilmenau (DE)

Correspondence Address: VENABLE, BAETJER, HOWARD AND CIVILETTI, LLP, P.O. BOX 34385, WASHINGTON, DC, 20043-9998, US

(21) Appl. No.: 09/913,067

(22) PCT Filed: Jan. 28, 2000
(86) PCT No.: PCT/EP00/00656

(30) Foreign Application Priority Data
Feb. 9, 1999 (DE) 19906162.9

(51) Int. Cl. G06M 7/00; B60L 5/00

(52) U.S. Cl. 191/95; 250/221

(57) ABSTRACT

A device for determining the pressure between a contact wire and a pantograph of an electrically-powered vehicle is provided with a measuring device for the static pressure that is determined from the distance between two elastically-connected components, the distance being a function of the static pressure, the device further having an acceleration sensor, which is coupled with the pantograph for determining the pantograph accelerations occurring in the direction of the pressure. The output signal of the acceleration sensor is linked with the output signal of the measuring device for calculating the pressure. The acceleration sensor is embodied to include a seismic mass (3) that is resiliently mounted to the pantograph (6) and whose respective position relative to the pantograph is optically detected, and a corresponding light signal is transmitted to an optoelectrical converter that is potential-isolated from the pantograph (6).

The invention relates to a device as defined in the preamble to claim 1.

Pantographs of modern high-speed rail vehicles are intended to be actively controlled with respect to the contact pressure between their contact strip and the contact wire so that an optimum can be found and maintained regarding the quality of the power supply and the wear to the contact point between the contact wire and the contact strip, regardless of the relative movements between the rail vehicle and the contact wire, the aerodynamic forces acting on the pantograph components due to the wind and the vehicle speed, and the vibratory behavior of the pantograph, the contact wire and the chain mechanism holding the wire. While the force component of the true contact pressure that results from the air flow over the pantograph components, as a function of the vehicle speed, can be determined through measurements and imposed as a parameter function for a control algorithm, the determination of the pressure resulting from the mechanical action of the pantograph and the overhead-line system requires a device that determines the magnitude and point of engagement of the pressure as close as possible to the contact point, and, from the measurement site, which is located at the high-voltage level (e.g., 3 kV DC voltage; 15 kV or 25 kV AC voltage), conducts pressure-equivalent signals to an evaluation device inside the vehicle, the signals having the opposite potential.

The international application PCT 98/DE01657 describes a device for measuring the pressure between a contact wire and a pantograph of an electrically-powered vehicle, particularly an electric rail vehicle. The device has at least one fiber-optic sensor that is suitable for determining the pressure between the contact wire and a contact strip of the pantograph, and a device for controlling the sensor and processing the sensor signals; a fiber-optic device that connects these devices is provided for a potential-isolated signal transmission. The fiber-optic sensor is intended to be disposed as close as possible to the actual contact point between the pantograph and the contact wire, and to measure the forces exerted between the components, directly and without large relative paths. The measuring device is intended to have the smallest possible influence on the vibratory and aerodynamic behaviors of the pantograph. The device should ascertain the pressure in terms of its magnitude and its point of engagement on the contact strip, and generate signals that are equivalent to the pressure and can be used for an actively-controlled pantograph.

For this purpose, two elastic deformation bodies are disposed between, and fixedly connected to, a base body of the contact strip and a contact-strip carrier (rocker frame), and a shoe and the base body of the contact strip, respectively. The deformation bodies support the contact strip or the shoe, and have an integrated fiber-optic reflective sensor that detects pressure-equivalent deformations of the deformation body and signals the device for controlling the sensor and processing the sensor signals. In this device, the detected deformations are converted into pressure-equivalent signals and outputted, or used to derive and output desired commands that are equivalent to changes in the pressure.

An advantage of disposing the elastic deformation bodies between the shoe and the base body of the contact strip is that the force components from the air flow that are dependent on the vehicle speed and are also acting as a lifting or lowering means are taken into consideration in the measurement. This solution, however, is structurally more complicated than in the arrangement of the deformation bodies between the base body of the contact strip and the contact-strip carrier. It has also been seen that these aerodynamic forces are essentially negligible.

It was found, however, that acceleration forces that are generated by vibrations of the contact wire and the pantograph occurring during travel are not accounted for by the known measuring device, but the actual pressure can increase or decrease significantly relative to the measured, “static” pressure. These acceleration forces can be calculated from the product of the mass and acceleration of the contact strip. Because the mass of the contact strip is known, ascertaining the acceleration suffices to determine the influence of the (positive or negative) acceleration of the pantograph on the pressure.

The measurement of the pantograph accelerations occurring in the direction of the pressure is effected with the aid of piezoelectric or capacitive acceleration recorders. These recorders are at the potential of the pantograph, i.e., at the high-voltage level, and generate electrical signals that must be reduced to the potential of the evaluation device through potential isolation. This type of potential isolation, however, is extremely costly, lowers the quality of the signals and, because of multiple filtering, only permits a low measuring frequency.

It is therefore the object of the present invention to provide a device for detecting the force between a contact wire and a pantograph of an electrically-powered vehicle, having a device for measuring the static pressure that is determined from the distance between two electrically-connected pantograph components, the distance being a function of the static pressure; the device further has an acceleration sensor that is coupled to the pantograph for determining the pantograph accelerations occurring in the direction of the pressure, with the output signal of the sensor being linked with the output signal of the measuring device for calculating the pressure. The device is intended to avoid the drawbacks associated with the potential isolation performed up to this point, thereby permitting a more exact determination of the pressure at a lower cost.

In accordance with the invention, this object is accomplished by the features disclosed in the characterizing portion of claim 1. The dependent claims disclose advantageous modifications of the device in accordance with the invention.

Because the acceleration sensor has a seismic mass (3), which is resiliently mounted to the pantograph (6), and whose respective position is detected optically, and a corresponding light signal is transmitted to an optoelectrical converter that is potential-isolated from the pantograph, the potential isolation is performed with simple means and without impeding the light signal on its optical path.

The light signal is preferably transmitted by a light guide, so the position of the optoelectrical converter in the vehicle can be freely selected.

A fiber-optic reflective sensor having a transmitted-light guide and a received-light guide is particularly well-suited as an acceleration sensor; here, the light-exit surface of the transmitted-light guide and the light-entrance surface of the received-light guide are located opposite a reflective surface of the seismic mass, and are fixed relative to the pantograph.

The accelerations that are of significance for the pressure have a maximum frequency of 20 to 25 Hz, so the measurement range should be between less than 1 Hz and 25 Hz. Accelerations having a frequency higher than 25 Hz have such a low amplitude that they are negligible. Accordingly, a resonance frequency of at least 80 Hz can be selected for the acceleration sensor. An excessively-high resonance frequency is detrimental to the sensitivity for the lower frequencies in the measurement range, particularly under 1 Hz.

The invention is described in detail below by way of an exemplary embodiment that is illustrated in the figure. The figure depicts the schematic structure of an acceleration sensor that is coupled to a pantograph, as is known from, for example, the cited PCT application 98/DE 01657.

The acceleration sensor essentially comprises a housing 1, which is only partially represented in the figure; a seismic mass 3 that is accommodated in the housing and coupled to it by way of springs 2; and a light guide that is fixedly connected to the housing, being guided into it, and comprises a transmitted-light guide 4 and a received-light guide 5. The housing 1 is fixedly connected to a component 6 of the pantograph, such as the rocker frame or a contact strip. The housing 1 and the light guide therefore move synchronously with the pantograph. The seismic mass 3, in contrast, follows the movements of the contact strip, with a delay, because of its resilient seating.

The transmitted-light guide 4 and the received-light guide 5 are disposed parallel to one another with a predetermined spacing, preferably directly adjacently, such that their end faces located in the housing 1, specifically the light-exit surface and light-entrance surface, respectively, extend parallel to a light-reflecting surface of the seismic mass 3 facing these surfaces. The transmitted-light guide 4 guides a transmitted light beam emitted by a light source in the vehicle, the beam exiting the end face of the guide and being incident at the reflective surface of the seismic mass 3. This light is reflected, with a portion of the reflected light being incident at the end face of the light-receiving guide [sic] 5, which guides it to an optoelectrical converter, in which a corresponding electrical signal is generated for further processing.

The ratio of the quantity of reflected light that is incident at the light-entrance surface of the received-light guide 5 to the quantity of light exiting the transmitted-light guide 4 depends on the distance of the end face of the light guide from the reflective surface of the seismic mass 3. Because this quantity of light follows the pantograph's movements, and thus those of the light guide, with a delay, the distance changes when the pantograph accelerates. The magnitude of the change depends on the acceleration. Therefore, the intensity of the light signal received by the received-light guide 5 and transmitted to the optoelectronic [sic] converter is a function of the positive or negative acceleration when the pantograph vibrates. The conversion of the light signal into an electrical signal and multiplication by the known mass of the pantograph results in a positive or negative force component that is added to the static pressure ascertained by, for example, the measuring device according to PCT 98/DE 01657 for obtaining the actual pressure between the contact wire and the pantograph. The arrow A in the figure indicates the direction of the pressure; namely, the seismic mass 3 vibrates in the direction of the pressure, so only pantograph accelerations in this direction are taken into account.

The acceleration sensor is at the electrical potential of the contact wire. Because the light guide is electrically insulating, however, a potential isolation occurs between the acceleration sensor and the optoelectrical converter, so its output zero signal can be set at a desired potential value.

1. A device for determining the pressure between a contact wire and a pantograph of an electrically-powered vehicle, having a measuring device for the static pressure that is determined from the distance between two elastically-connected pantograph components, the distance being a function of the static pressure, the device further having an acceleration sensor, which is coupled with the pantograph for determining the pantograph accelerations occurring in the direction of the pressure, with the output signal of the sensor being linked with the output signal of the measuring device for calculating the pressure, characterized in that the acceleration sensor has a seismic mass (3) that is resiliently mounted to the pantograph (6), and whose respective position is optically detected, and a corresponding light signal is transmitted to an optoelectrical converter that is potential-isolated from the pantograph (6).

2. The device according to claim 1, characterized in that a light guide (4, 5) is provided for transmitting the light signal.

3. The device according to claim 1 or 2, characterized in that the seismic mass (3) is resiliently seated in a housing (1) that is fixedly connected to the pantograph (6).

4. The device according to one of claims 1 through 3, characterized in that, for optically determining the position of the seismic mass (3), a fiber-optic reflective sensor is provided with a transmitted-light guide (4) and a received-light guide (5), with the light-exit surface of the transmitted-light guide (4) and the light-entrance surface of the received-light guide (5) being located opposite a reflective surface of the seismic mass (3) and fixed relative to the pantograph (6).

5. The device according to claim 4, characterized in that the ratio of the quantity of light entering the received-light guide (5) to the quantity of light exiting the transmitted-light guide (4) depends on the distance of the reflective surface of the seismic mass (3) from the light-entrance and light-exit surfaces of the reflective sensor.

6. The device according to one of claims 1 through 5, characterized in that the measurement range of the acceleration sensor is less than 25 Hz.

7. The device according to claim 6, characterized in that the resonance frequency of the acceleration sensor is higher than 80 Hz.
